(19) United States
(12) Patent Application Publication
(10) Pub. No.: US 2026/0276443 A1
(43) Pub. Date: Sep. 17, 2026

(54) Method to Correct Glass Window to SCE Measurement

(71) Applicant: DATACOLOR INC., LAWRENCEVILLE, NJ (US)

(72) Inventors: Zhiling Xu, Princeton Junction, NJ (US); William Bishop, Bristol, PA (US)

(73) Assignee: DATACOLOR INC., LAWRENCEVILLE, NJ (US)

(21) Appl. No.: 19/080,639

(22) Filed: Mar. 14, 2025

(51) Int. Cl. G01J 3/02; G01J 3/50

(52) U.S. Cl. CPC G01J 3/027; G01J 3/0251; G01J 3/501

(57) ABSTRACT

This disclosure describes a color measurement system for improved specular component excluded (SCE) measurements. The system incorporates an integrating sphere with an SCE sensor and light source, with a transparent window placed between the SCE sensor and the sample. A processor activates the light source, receives sensor values from reflected light off a sample, and obtains a measurement calibration factor. The system corrects SCE measurements using this calibration factor. The measurement calibration factor can include at least the transparent window's transmittance value, allowing for accurate color readings by compensating for the transparent material's influence on light transmission.

### FIELD OF THE INVENTION

The systems, methods, devices and processes described herein are directed to the correction of SCE measurements to account for the error introduced by the presence of glass in the measurement window of integrating spheres.

### BACKGROUND OF THE INVENTION

Sphere-based color measurement instruments are widely used in the industry, such as Datacolor's benchtop Spectro 1000 spectrophotometers or handheld P300 spectrophotometers. For such an instrument, sometimes it is needed to add a glass window at the sample port when measuring a sample, either for protecting the instrument from the environmental contamination, or for better contact of the sample. With the addition of the glass window, the measurement result will be impacted, and an error will be induced.

In AATCC Manual of International Test Method and Procedures EP6-2021 A1.4.3, an equation is given to correct this glass-induced error. However, this equation only works for Specular Component Included (SCI) configurations.

However, it is often important to also obtain light or color measurements using Specular Component Excluded (SCE) measurement configurations. The art does not presently provide for devices or methods that correct for the error introduced by glass measurement windows in SCE configuration measurement.

Thus, what is needed in the art is an apparatus, as well as systems, processes or methods that allow for the correction of glass-induced measurement error when deploying SCE configurations.

### SUMMARY OF THE INVENTION

In the disclosure provided herein, the apparatus, systems and methods are directed to an improved color measurement system. In one arrangement, the improved system includes an integrating sphere having at least one specular component excluded (SCE) sensor, separated by a transparent window from the interior of the integrating sphere. The one specular component excluded (SCE) sensor is configured to output a signal in response to light incident thereupon. The system also includes a light source, and at least one processor having a memory. Here, the processor is configured to activate the light source so as to cause a beam of light to be directed into the sphere and provide illumination to a sample placed at the sample port of the integrating sphere. The processor is further configured to receive a value output by the SCE sensor generated in response to light that has been reflected off a sample and obtain at least one measurement calibration factor value. The processor is further configured to generate a corrected SCE measurement value using at least the SCE sensor output value and the at least one obtained measurement calibration factor; and output at least the corrected SCE measurement value.

In a further arrangement, the transparent window of the integrating sphere further is made of glass with a low light absorbance value. In yet a further arrangement, wherein the at least one measurement calibration factor value is the transmittance value (T) of the transparent window. In a further arrangement, the processor is further configured to calculate the corrected SCE measurement value (R) using the formula: R=Rg/(2T−T²*Rg), where T is the transmittance value and Rg is the actual measured value obtained from the SCE sensor.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a schematic diagram of an apparatus incorporating the subject matter described herein.

FIG. 2 is an illustration of the behavior of light in the glass window before entering the integrating sphere and received by the pickup optics and the detector.

FIG. 3 is a flow diagram detailing the steps taken according to one or more methods or processes described herein.

FIG. 4 is a schematic diagram detailing specific modules of a processor described herein.

FIG. 5 is a graph detailing the performance of the subject matter described herein.

FIG. 6 is a graph detailing the performance of the subject matter described herein relative to alternative approaches.

### DETAILED DESCRIPTION OF THE INVENTION

In the disclosure provided herein, the apparatus, systems and methods are directed to improved measurements obtained from color measurement devices employing an integrating sphere.

By way of overview, some color measurement devices, such as those carried out using measurement devices made by Datacolor Inc. of Lawrenceville N.J., are spectrophotometers that incorporate integrating sphere devices to measure the color properties of samples. The described apparatus, method and systems described herein are directed to the measurement of at least specular component excluded (SCE) reflectances for a sample. It will be understood that some versions of integrating spheres also provide for specular component included (SCI) measurements. The described apparatus, systems and methods described herein can be used with integrating spheres that have at least an SCE measurement configuration and can be utilized and integrated into measurement devices that incorporate both SCI and SCE measurement configurations.

In one or more implementations, the present disclosure is directed to error corrections of measurements made in a SCE configuration resulting in improved accuracy of color measurements when a transparent window needs to be used during the measurement operation. As a result, the described approaches provide for a non-routine, non-customary technical solution to the technical problem encountered in SCE measurement operations. The color measurement devices incorporating the subject matter of the foregoing disclosure provide improved accuracy and elimination of errors associated with current measurement devices in the art. Thus, the subject matter described herein represents a tangible, real-world solution to the problem of measurement errors introduced by the placement of transparent (such as but not limited to glass) windows in integrating spheres when SCE measurements are made.

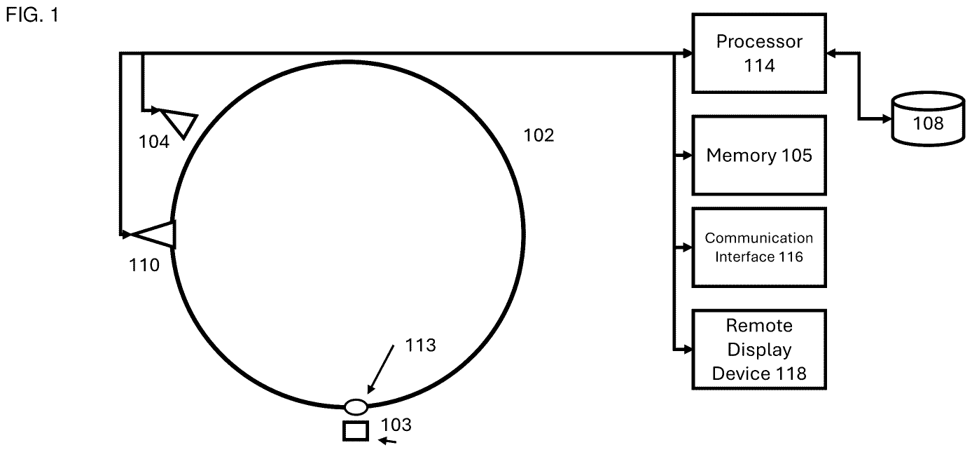

Turning now to the schematic illustration provided in FIG. 1. In one or more configurations, the described apparatus or system includes a measurement device includes an integrating sphere 102. In one or more implementations, the integrating sphere 102 is utilized to obtain color measurements of a sample 103 under analysis. In one implementation, sample 103 is a color swatch, fan deck, color sample, product, item or object. For example, the sample 103 is a piece of material where the color of the material is desired to be known. In another implementation, the sample 103 is any object where the color values of an object are unknown and desired or known and in need of clarification or confirmation.

In one or more implementations, the integrating sphere 102 includes an interior cavity that is defined by an interior surface. The interior of the integrating sphere 102 has a reflective, optically diffuse, surface. In many configurations, the inner surface of the integrating sphere 102 is white and highly reflective. In one particular implementation, the interior of the integrating sphere 102 is coated with materials having a high diffuse reflectance value. For example, in one arrangement materials such as Spectralon®, Teflon® or a similar material is coated or applied to the interior of the integrating sphere 102. In another arrangement, the coating selected is configured to reflect 99% or greater of the incident light directed into the integrating sphere 102 in the wavelengths from 300 nm to 900 nm. In another implementation, the interior of the integrating sphere is coated with a barium sulfate-based paint which possess a lower reflectance relative to Spectralon®.

In the illustrated arrangement of FIG. 1, the integrating sphere 102 includes a light source 110. In a particular configuration, the light source 110 is an incandescent lamp, Xenon lamp, fluorescent light, infrared light source, or light emitting diode (LED). In a further embodiment, the LED is a high color-rendering-index broadband LED. In a more particular configuration, the light source 110 is any light source that is controlled in response to a control signal and produces light. As used throughout, the light source 110 is configured to emit light in pulses or a steady beam. In a further implementation, the light source 110 is equivalent or substantially similar to the light source provided in the Datacolor spectrophotometer family of products. The light source 110 is used to illuminate sample 103 in order to provide an analysis of color, light transmission and/or reflective properties.

The integrating sphere in at least one implementation, also includes at least one SCE sensor 104. In one or more implementations, the SCE sensor 104 is one or more photometers, light sensing elements, or other similar devices. In a further implementation, the SCE sensor 104 is one or more cameras or image acquisition devices such as CMOS (Complementary Metal Oxide Semiconductor), CCD (charged coupled device) or other color measurement devices. Such sensors can include data acquisition devices and associated hardware, firmware and software that is used to generate color values for a given sample.

In a further implementation, SCE sensor 104 is configured to communicate with the associated processors, networks, and storage devices using one or more USB, FIREWIRE, Wi-Fi, GSM, Ethernet, Bluetooth, and other wired or wireless communication technologies suitable for the transmission color, image, spectral, or other relevant data and or metadata. In an alternative arrangement, the SCE sensor 104 is a module or component of a computing workstation, testing bench, or other evaluative apparatus.

In one or more implementations, the integrating sphere 102 includes an aperture that permits light to be directed into the sensor 104. In one arrangement, the aperture is covered by a transparent window 113. In one arrangement, the transparent 113 window is formed of glass. However, in alternative implementations the transparent window 113 is formed from quartz, sapphire, acrylic, cyclic olefin polymers, or copolymers, or specialty optical glasses. In each case the selected transparent window 113 has low light absorption properties.

With further reference to FIG. 1, a processor 114 is communicatively coupled to the light source 110, the SCE sensor 104. In one or more implementations, the processor 114 is communicatively coupled directly to each illustrated component. However, in one or more further implementations, the processor 114 is configured to communicate with a bus, hub, interface, or other component that manages the operation of one or more components based on processor 114 instructions.

In one particular implementation, the processor 114 is a computing device, such as a commercially available microprocessor, processing cluster, integrated circuit, computer on chip or other data processing device. In one or more configurations, the processor 114 is one or more components of a cellphone, smartphone, notebook or desktop computer configured to directly, or through a communication linkage, receive color measurement data captured by the SCE sensor 104. The processor 114 is configured with code executing therein to access various peripheral devices and network interfaces. For instance, the processor 114 is configured to communicate over the Internet with one or more remote servers, computers, peripherals or other hardware using standard or custom communication protocols and settings (e.g., TCP/IP, etc.).

In one configuration, the processor 114 is a portable computing device such as an Apple iPad/iPhone® or Android® device or other commercially available mobile electronic device executing a commercially available or custom operating system, e.g., MICROSOFT WINDOWS, APPLE OSX, UNIX or Linux-based operating system implementations. In other embodiments, the processor 114 is, or includes custom or non-standard hardware, firmware or software configurations. For instance, the processor 114 comprises one or more of a collection of micro-computing elements, computer-on-chip, home entertainment consoles, media players, set-top boxes, prototyping devices or “hobby” computing elements. The processor 114 can comprise a single processor, multiple discrete processors, a multi-core processor, or other type of processor(s) known to those of skill in the art, depending on the particular embodiment.

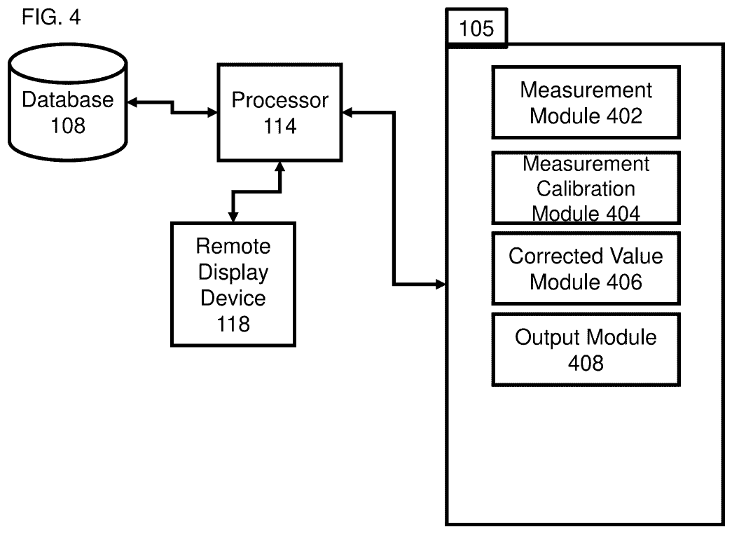

The output signals generated by the sensor 104 are transmitted to one or more processor(s) 114 for evaluation as a function of one or more hardware or software modules. As used herein, the term “module” refers, generally, to one or more discrete components that contribute to the effectiveness of the presently described systems, methods and approaches. Modules can include software elements, including but not limited to functions, algorithms, classes and the like. In one arrangement, the software modules are stored as software in memory of processor 114, as shown in FIG. 4.

Modules can, in some implementations, include discrete or specific hardware elements. In one implementation, processor 114 is located within the same device or enclosure as the light measurement sensor 104. For example, both the processor 114 and light measurement sensor 104 are components of a spectrophotometer. However, in another implementation, processor 114 is remote or separate from the light measurement sensor 104 and communicates over one or more communication linkages.

In one configuration, processor 114 is configured through one or more software modules to generate, calculate, process, output, or otherwise manipulate the output signals generated by the light measurement sensor 104.

In one or more embodiments, the processor 114 is directly or indirectly connected to one or more memory storage devices (memories) to form a microcontroller structure. The memory is a persistent or non-persistent storage device (such as memory 105) that is operative to store the operating system in addition to one or more of software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules. In one or more embodiments, the memory of the processor 104 provides for the storage of application program and data files. One or more memories provide program code that the processor 114 reads and executes upon receipt of a start, or initiation signal. The computer memories may also comprise secondary computer memory, such as magnetic or optical disk drives or flash memory, that provide long term storage of data in a manner similar to the persistent memory device 105. In one or more embodiments, the memory 105 of the processor 114 provides for storage of application programs or modules and data files when needed.

As shown, memory 105 and persistent storage 108 are examples of computer-readable tangible storage devices. A storage device is any piece of hardware that is capable of storing information, such as data, program code in functional form, and/or other suitable information on a temporary basis and/or permanent basis. In one or more embodiments, memory 105 includes random access memory (RAM). RAM may be used to store data such as measurement data in accordance with the present invention. In general, memory can include any suitable volatile or non-volatile computer-readable storage device. Software and data are stored in persistent storage 108 for access and/or execution by processors 114 via one or more memories of memory 105.

In a particular embodiment, persistent storage 108 includes a magnetic hard disk drive. Alternatively, or in addition to a magnetic hard disk drive, persistent storage 108 can include a solid-state hard drive, a semiconductor storage device, read-only memory (ROM), erasable programmable read-only memory (EPROM), flash memory, or any other computer-readable storage devices capable of storing program instructions or digital information.

The database 108 may be embodied as solid-state memory (e.g., ROM), hard disk drive systems, RAID, disk arrays, storage area networks (“SAN”), network attached storage (“NAS”) and/or any other suitable system for storing computer data. In addition, the database 108 may comprise caches, including database caches and/or web caches. Programmatically, the database 108 may comprise flat-file data store, a relational database, an object-oriented database, a hybrid relational-object database, a key-value data store such as HADOOP or MONGODB, in addition to other systems for the structure and retrieval of data that are well known to those of skill in the art.

The media used by persistent storage 108 may also be removable. For example, a removable hard drive may be used for persistent storage 108. Other examples include optical and magnetic disks, thumb drives, and smart cards that are inserted into a drive for transfer onto another computer-readable storage medium that is also part of persistent storage 108.

Communications or network interface unit 116, in these examples, provides for communications with other sub-systems or devices. In an embodiment, communications interface 116 may provide appropriate interfaces to the Internet or other suitable data communications networks to connect to one or more servers, resources, API hosts, or computers. In these examples, communications unit 116 may include one or more network interface cards. Communications unit 116 may provide communications through the use of either or both physical and wireless communications links.

In one or more implementations, the remote display device 118 is a screen, monitor, display, LED, LCD or OLED panel, augmented or virtual reality interface, or an electronic ink-based display device. However, in one or more implementations, the display device is remote from the processor 114. For example, in one or more implementations, the remote display device 118 is a smartphone or other device that is configured to receive measured and processed data from the processor 114 and display it to a user. Where the processor 114 or communication device is configured to communicate using Bluetooth or another communication technology, the remote display device 118 is configured to exchange data with the processor 114. Such data exchanges may include instructions to begin a measurement operation or update measurement calibration factors. Likewise, the results or measurements obtained using the integrating sphere may be provided to the remote display device 118 through the use of one or more software applications that reside on the remote display device 118. Such “app” based data interfaces allow for the hardware of the integrating sphere to be simplified and allow for remote device management and operation.

Those possessing an ordinary level of skill in the requisite art will appreciate that additional features, such as power supplies, power sources, power management circuitry, control interfaces, relays, adaptors, and/or other elements used to supply power and interconnect electronic components and control activations are appreciated and understood to be incorporated.

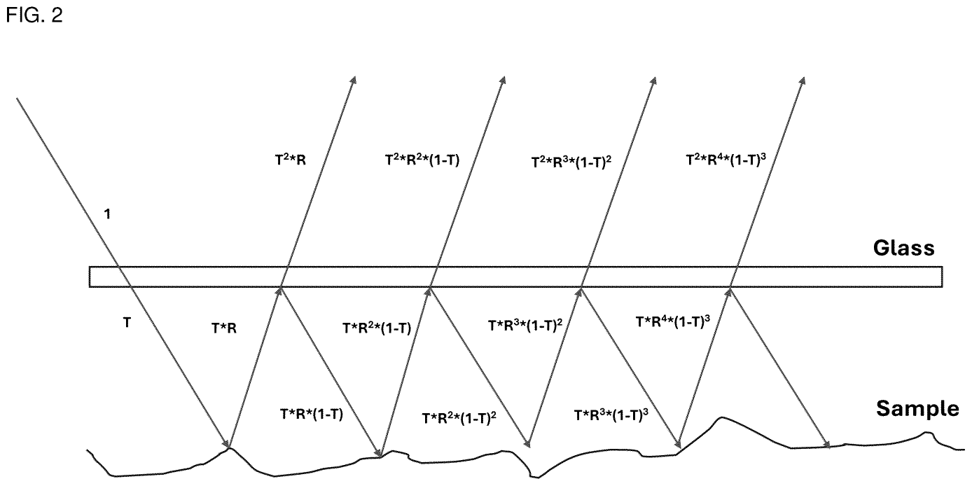

Turning now to FIG. 2-4, a system, method and computer implemented process for obtaining more accurate color measurements is described.

However, by way of background, it will be appreciated by those possessing an ordinary level of skill in the requisite art that a sphere-based instrument can measure a color sample under either specular included (SCI) configuration or specular excluded (SCE) configuration. When adding a transparent window between the instrument and the measurement sample, the measurement result will be impacted, and an error will be induced. For SCI configuration, a well-known method has been used, as suggested by AATCC EP6-2021 A1.4.3 (herein incorporated by reference as if presented in its entirety), to correct the measurement error.

For a sphere-based color measurement instrument, when measuring a sample under specular component excluded (SCE) configuration, the sample is illuminated by diffuse light from all directions except for the specular direction. When adding a piece of transparent material between the sample port of the instrument and the sample, due to the surface reflection and body absorption, the signal reaching the light sensor will be impacted, and thus an error will be induced.

As shown in FIG. 2, the light originally shines onto the sample (with total intensity 1) will be partially blocked by the glass. Assume the transmittance of glass is T, then the light intensity reaching the sample is only 1*T. Also assume the reflectance of the sample is R, then the light reflected from the sample is T*R. Part of the light will pass through the glass with the intensity of T²*R, and part of the light will be reflected back towards the sample by the glass, with the intensity of T*R*(1−T). This process will be repeated infinitely, so the light eventually reaching the detector will be:

$${R}_{g} = {T}^{2} * R + {T}^{2} * {R}^{2} * ( 1 - T ) + {T}^{2} * {R}^{3} * {( 1 - T )}^{2} + {T}^{2} * {R}^{4} * {( 1 - T )}^{3} + … \qquad ( 1 )$$

This can be easily calculated as:

$${R}_{g} = \frac{{T}^{2} * R}{1 - R * ( 1 - T )} \qquad ( 2 )$$

Where R_{g} represents the light that is detected by the receiver. In equation (2), R_{g} is the measured reflectance of the sample that is impacted by the glass window, Tis the transmittance of the glass window, and R is the actual reflectance of the sample not impacted by the glass window.

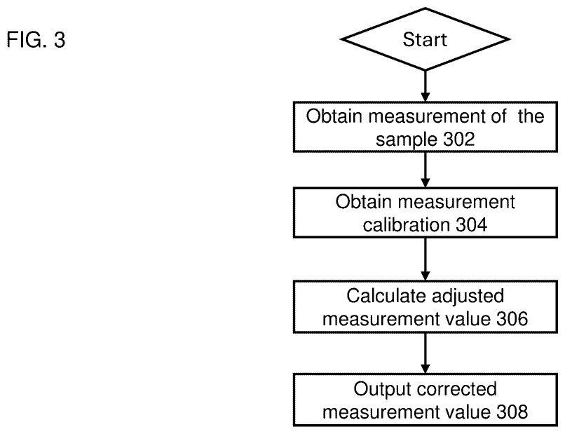

With reference to FIGS. 3 and 4, a process of determining the corrected reflectance measurement includes a first step 302 of causing the illuminator 110 to illuminate the sample 103. For example, a measurement module 402 configured one or more processors 114 to activate the illuminator 110. Upon illumination of the sample, the sensor 104 is configured to output a value that correspond to the reflectance of the sample under measurement. Through the measurement module 402, the output of the measurement made by the sensor 104 is received by the one or more processors 114. This measurement value can be stored in the data storage 105 or persistent storage devices 108 for further use.

Turning to step 304, a measurement calibration factor value is obtained for the measurement under analysis. In one implementation, the processor 114 is configured to access a measurement calibration factor value from one or more data storage or databases. For example, a measurement calibration factor module 404 configures one or more processors 114 to access a stored calibration value from memory 105. In a particular implementation, the measurement calibration factor value is the transmittance value of the glass used in the window separating the sensor from the interior of the integrating sphere. In one or more particular arrangements, the memory 105 includes a plurality of different T values for different materials. Further, in one or more particular arrangements, the memory 105 includes a plurality of different T values for different wavelengths. However, in one or more particular implementations, the processor 114 is configured to receive user input for the value of T. For instance, where the transparent material used does not have a stored T value, the user is able to supply a custom T value for use in further measurements. The color measurement system of claim 3, wherein the processor is further configured to obtain the transmittance value (T) of the transparent window by receiving a user input value.

Turning now to step 306, a corrected measurement value for the sample under analysis is generated. In one implementation, one or more processors 114 are configured by a corrected value module 406 to generate a corrected SCE measurement value. In one arrangement, the corrected value module 406 is configured to access both the reflectance value of the transparent material used in the measurement device and the measurement obtained from the sensor 104. Here, the absorption of the transparent window is assumed to be negligible. Thus, the processor 114 is configured to determine the true reflectance value R (as shown in equation (2)) through the use of the value for T and the actual measurement value Rg. In one arrangement, such a calculation is carried out according to:

$$R = \frac{{R}_{g}}{{R}_{g} - {R}_{g} * T + {T}^{2}} \qquad ( 3 )$$

As shown in step 306, the processor 114, suitably configured, is now able to obtain an improved reflectance value for the sample R from the measured reflectance R_{g}.

As shown in step 308, once the corrected measurement value is obtained, it can be output for further use. In one or more implementations, a processor 114 is configured by an output module 408 to send the corrected measurement value to one or more display devices. For example, where the measurement device includes a connected or remote display device, the measurement values are provided to the display device for evaluation by the user. Similarly, the output module 408 configures one or more processors 114 to provide the corrected measurement to one or more data storage locations for further use and reference.

In yet a further arrangement, the output module 408 configures one or more processors 114 to provide the corrected measurement to one or more remote computing devices. In one or more arrangements, the measurement device described (the integrating sphere, processor, and associated components) is configured to be operable by one or more remote computing devices. For example, in one arrangement, the measurement device is configured to be operated by a software application (or ‘app’) operating on a remote computing device, such as a smartphone or tablet computer. In this configuration, the measurement and processing of the data obtained by the sensor 104 is carried out by the integrated processor 114. However, this information is then transferred to the device hosting the application. Through the application, a user is able to control the functionality of the measurement device, as well as receive the results of measurements. In one or more implementations, both the original and corrected measurements are provided via the connected software.

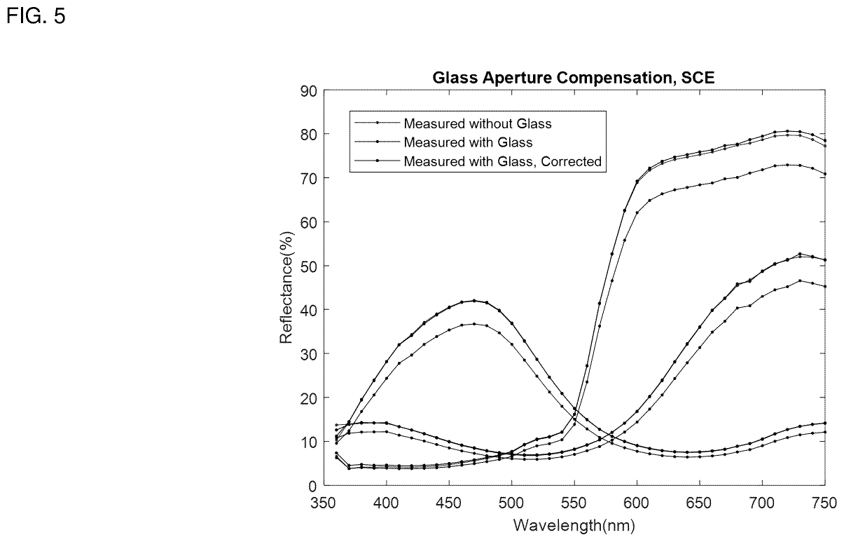

It has been found by the inventors that the described approach provides for an improvement to the accuracy of a measurement device that engages in SCE measurements where there is a glass separating the measurement device from the measurement sample 103. For example, the improvements made by the present approach are verified. Turning now to FIG. 5, a sphere-based instrument was calibrated under SCE configuration without the glass window. Using this measurement configuration, a set of 12 ceramic tiles were measured and the measurement results were stored to a data storge device. The same measurement configuration was adjusted to add a glass window. Without recalibrating the instrument, the same set of 12 ceramic tiles were measured.

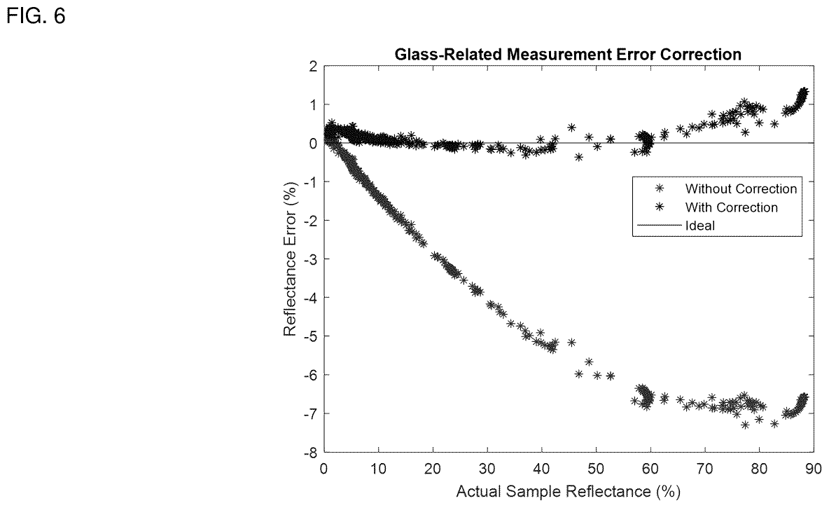

As shown in FIG. 6, the results of samples measured with glass, before and after correction with equation (3), compared to the same samples measured without glass. As such, it is shown that the described approach can be used to correct the glass-induced measurement differences and reduce the error associated therewith. Thus, the described approach represents an improvement over approaches that require the removal of the glass window or utilize measurements with known, and uncorrected, errors.

While this specification contains many specific embodiment details, these should not be construed as limitations on the scope of any embodiment or of what can be claimed, but rather as descriptions of features that can be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter have been described in this specification. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Publications and references to known registered marks representing various systems cited throughout this application are incorporated by reference herein. Citation of any above publications or documents is not intended as an admission that any of the foregoing is pertinent prior art, nor does it constitute any admission as to the contents or date of these publications or documents. All references cited herein are incorporated by reference to the same extent as if each individual publication and reference were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the claims that follow, the respective features recited in those claims, and by equivalents of such features.

What is claimed is:

1. A color measurement system comprising:
an integrating sphere having at least one specular component excluded (SCE) sensor configured to output a signal in response to light incident thereupon and a light source, wherein a transparent material is disposed between the specular component excluded (SCE) sensor and the sample; and
at least one processor having a memory and configured to:
activate the light source so as to cause a beam of light to be directed into the sphere and provide illumination to a sample placed at the sample port of the integrating sphere;
receive a value output by the SCE sensor generated in response to light that has been reflected off a sample;
obtain at least one measurement calibration factor value;
generate a corrected SCE measurement value using at least the SCE sensor output value and the at least one obtained measurement calibration factor; and
output at least the corrected SCE measurement value.

2. The color measurement system of claim 1, wherein the transparent material is a glass window positioned between the sample and the SCE sensor.

3. The color measurement system of claim 1, wherein the at least one measurement calibration factor value includes the transmittance value (T) of the transparent material.

4. The color measurement system of claim 3, wherein the processor is further configured to calculate the corrected SCE measurement reflectance value (R) using the formula:
$$R = {R}_{g} / ( 2 T - {{T}^{2}}^{*} {R}_{g} )$$
wherein R_{g} is the reflectance value output by the SCE sensor.

5. The color measurement system of claim 3, wherein the processor is further configured to obtain the transmittance value (T) of the transparent window from a memory storing predetermined transmittance values for a plurality of transparent materials, and/or a plurality of wavelengths.

6. The color measurement system of claim 3, wherein the processor is further configured to obtain the transmittance value (T) of the transparent window by receiving a user input value.

7. A method of correcting a specular component excluded (SCE) color measurement, the method comprising:
directing light from a light source into an integrating sphere, the integrating sphere having a specular component excluded (SCE) sensor positioned to receive light reflected from the sample through a glass window;
receiving a measured specular component excluded (SCE) value (Rg) from the SCE sensor;
obtaining a transmittance value (T) of the glass window;
calculating a corrected specular component excluded (SCE) value (R) using the formula:
$$R = Rg / ( 2 T - {{T}^{2}}^{*} Rg )$$
outputting the corrected specular component excluded (SCE) value (R).

8. The method of claim 7, wherein obtaining the transmittance value (T) of the glass window comprises retrieving the transmittance value from a memory storing a plurality of predetermined transmittance values for different glass windows and/or different wavelengths.

9. The method of claim 7, wherein obtaining the transmittance value (T) of the glass window comprises receiving the transmittance value as a user input.

10. The method of claim 7, wherein directing light from a light source comprises activating a light-emitting diode (LED) light source within the integrating sphere.

11. A specular component excluded (SCE) color measurement apparatus comprising:
an integrating sphere, the integrating sphere having a specular component excluded (SCE) sensor positioned to receive light reflected from the sample through a glass window; wherein a glass window is positioned between the specular component excluded (SCE) sensor and the sample;
at least one local processor configured by code executing therein to:
cause an illuminator to illuminate the sample;
obtain a reflectance measurement value of the sample by receiving the output from the specular component excluded (SCE) sensor while the sample is illuminated;
obtain a transmittance value (T) of the glass window from a remote data storage location;
calculate a corrected specular component excluded (SCE) value; and
outputting the corrected specular component excluded (SCE) value;
at least one remote processor, configured by code executing therein to:
receive at least the outputted corrected specular component excluded (SCE) value; and
display at least corrected specular component excluded (SCE) value on a display device connected the at least one remote processor.

12. The apparatus of claim 11, wherein the at least one remote processor is further configured to store the received corrected specular component excluded (SCE) value in a remote database.

13. The apparatus of claim 11, wherein the illuminator is a light-emitting diode (LED) with a spectral distribution approximating CIE Standard Illuminant D65.

14. The apparatus of claim 11, wherein the at least one local processor is configured to calculate the corrected specular component excluded (SCE) value (R) using the formula:
$$R = {R}_{g} / ( 2 T - {{T}^{2}}^{*} {R}_{g} )$$
wherein R_{g} is the reflectance measurement value output from the specular component excluded (SCE) sensor.

15. The apparatus of claim 11, wherein the at least one local processor and the at least one remote processor communicate via a wireless network connection.

16. The apparatus of claim 11, wherein the display device connected to the at least one remote processor is a color-calibrated touchscreen display configured to display the corrected specular component excluded (SCE) value and allow for user interaction with the displayed data.
